(19) United States
(12) Patent Application Publication
(10) Pub. No.: US 2013/0314844 A1
(43) Pub. Date: Nov. 28, 2013

(54) METHOD OF PREPARING REDUCED GRAPHENE OXIDE FOAM

(71) Applicant: NANYANG TECHNOLOGICAL UNIVERSITY, Singapore (SG)

(72) Inventors: Xiaodong CHEN, Singapore (SG); Zhiqiang NIU, Singapore (SG); Jan MA, Singapore (SG)

(73) Assignee: NANYANG TECHNOLOGICAL UNIVERSITY, Singapore (SG)

(21) Appl. No.: 13/901,184

(22) Filed: May 23, 2013

Related U.S. Application Data
(60) Provisional application No. 61/650,705, filed on May 23, 2012.

(51) Int. Cl. C01B 31/04

(52) U.S. Cl. CPC C01B 31/043
USPC 361/502; 423/415.1

(57) ABSTRACT

A method of preparing a reduced graphene oxide foam, the method comprising the steps of: preparing a colloidal suspension of graphene oxide; forming a graphene oxide compact layered film from the colloidal suspension of graphene oxide using flow-directed assembly; and chemically reducing the graphene oxide compact layered film using a chemical reducing agent to form a porous and continuous cross-linked structure that is the reduced graphene oxide foam.

### FIELD OF THE INVENTION

This invention relates to a method of preparing a reduced graphene oxide (rGO) foam, and in particular, but not limited to, a leavening strategy to prepare rGO foams with porous and continuous cross-linked structures.

### BACKGROUND OF THE INVENTION

Integration of two-dimensional (2D) nanoscale building blocks, such as graphene sheets, into three-dimensional (3D) macroscopic structures (e.g., layered films and porous scaffolds) is drawing much attention since it is an essential step to explore the advanced properties of individual 2D sheets for practical applications.^{[1-32]} For instance, free-standing graphene macroscopic structures have shown unique catalytic, electrochemical, and mechanical properties together with potential applications in chemical filters and electrodes for energy storage devices.^{[6-8,11,30]} However, in most cases, during the assembly process of nanoscale building blocks to macroscopic paper-like structures, the large accessible surface area of 2D graphene sheets is lost. The reason is that the individual graphene sheets tend to irreversibly aggregate and restack due to the strong π-π stacking and van der Waals force between the planar basal planes of graphene sheets. This deleteriously affects the potential applications of graphene materials in electrochemical electrodes, composite materials, and so on.^{[20]}

Because of the unique nanostructure and properties, graphene and its functional derivatives has shown the potential as nanoscale basic building block to assemble novel macroscale structure with functionalities.^{[30, 8, 11]} Among these macroscale structures, free-standing paper-like structures have attracted extensive interest because of their unique catalytic, electrochemical and mechanical properties together with potential applications in chemical filters, electrodes of batteries and supercapacitors.^{[30, 8]} However, during the assembling process from nanoscale to macroscale paper-like structures, the graphene or reduced graphene oxide (RGO) sheets tend to form irreversible agglomerate, behaving as particulate graphite platelets, due to the strong van der Waals force between the large and planar basal planes and the hydrophobicity with high degree.^{[57]} As a result, the ultrahigh surface area of 2D graphene sheets is lost and the aggregated graphene-based macroscale paper-like structures have relatively low surface area. This deleteriously affects the potential applications of graphene in many fields such as supercapacitors, batteries, composite materials.

Therefore, preventing aggregation of graphene sheets in the macroscopic structures, such that the properties of the individual graphene sheets are not compromised, is a critical challenge in constructing functional graphene-based macroscopic structures. Currently, a number of strategies for preventing aggregation have been developed, which include adding the “spacers” (i.e. surfactants, nanoparticles, polymers),^{[27-36]} template-assistance growth,^{[37]} crumpling the graphene sheets,^{[18, 38]} and so on. Much effort has been made to overcome the self-aggregation by adding the “spacer”, such as nanoparticles, nanowires, polymer and biomolecules into to the paper-like structures to separate the graphene sheets.^{[30, 58, 59, 33, 60, 14]}

Alternatively, several groups have reported the formation of free-standing 3D graphene-based macroscopic structures without the assistance of any spacers for templates.^{[7, 39-40]} For instance, Li et al. reported the preparation of free-standing multilayered graphene films by vacuum-assisted filtration based on the effective prevention of graphene intersheet restacking.^{[7]} Shi et al demonstrated the formation of 3D graphene hydrogel by hydrothermal method.^{[39]} However, preparing free-standing and flexible graphene films without complicated processing but with large accessible surface area by overcoming the aggregation of graphene sheets remains a challenge. The attention paid to the preparation of paper-like structures, in which self-aggregation was overcome and no “spacer” was needed, is scarce. How to overcome the self-aggregation only by cross-link between graphene sheets and achieve large-area paper-like structures remains a challenge.

In an earlier work, using vacuum filtration method, Ruoff and coworkers have successfully prepared graphene oxide (GO) compact layered films^{[11]}. However, it is known that GO is rather unstable, and can be chemically reduced under mild heating to yield reduced GO (rGO) and gaseous species such as H₂O and CO₂.^{[41-44]}

### SUMMARY OF INVENTION

A leavening strategy is provided to prepare rGO foams with porous and continuous cross-linked structures. Such rGO foams have been demonstrated to perform as flexible electrode materials for supercapacitors and selective organic absorbents for selective absorption of oil and organic solvents for environmental clean-up.

By incorporating the gas released during chemical reduction of GO compact layered films, like the leavening procedure to add gas to produce lighter, more easily chewable bread with the porous structures from compact dough before or during baking or steaming, porous graphene structures (i.e. rGO foams) just like “leavened bread” can be formed. This has now been achieved by an autoclaved leavening process.

According to a first aspect, there is provided method of preparing a reduced graphene oxide foam, the method comprising the steps of: preparing a colloidal suspension of graphene oxide; forming a graphene oxide compact layered film from the colloidal suspension of graphene oxide using flow-directed assembly; and chemically reducing the graphene oxide compact layered film using a chemical reducing agent to form a porous and continuous cross-linked structure that is the reduced graphene oxide foam.

The chemically reducing may comprise heating the graphene oxide compact layered film in the presence of the chemical reducing agent in a sealed environment such that gas that is released during the chemical reduction forms pores in the layered film to form the porous graphene oxide network.

The chemical reducing agent may comprise hydrazine monohydrate.

The graphene oxide compact layered film may be prevented from being in direct wetting contact with the chemical reducing agent in the sealed environment and may be allowed to contact only the vapour of the chemical reducing agent in the sealed environment.

The heating may be at a temperature of about 90° C. for about 10 hours.

The flow-directed assembly may comprise filtering the colloidal suspension of graphene oxide through a porous membrane to obtain the graphene oxide compact layered film on the porous membrane.

The method may further comprise removing the graphene oxide compact layered film from the porous membrane before chemically reducing the graphene oxide compact layered film.

The porous membrane may be an anodized aluminium oxide membrane having a pore size of about 20 nm.

The degree of porosity in the reduced graphene oxide foam may be controlled by the volume of the chemical reducing agent used.

The method of any preceding claim, wherein the volume of the chemical reducing agent used ranges from about 5 μL to about 40 μL.

According to a second aspect, there is provided an oil absorbent comprising a reduced graphene oxide foam prepared according to the method of the first aspect, the reduced graphene oxide foam being hydrophobic and exhibiting superwetting behaviour for organic solvents.

The oil absorbent may have an oil absorption capacity of about 1.1 ton m⁻³.

According to a third aspect, there is provided a flexible supercapacitor having a current collector and an electrode, each of the current collector and the electrode comprising a reduced graphene oxide foam prepared according to the method of the first aspect.

The flexible supercapacitor may further comprise a flexible separator and an electrolyte disposed between the current collector and the electrode.

The reduced graphene oxide foam may be provided on a flexible substrate.

### BRIEF DESCRIPTION OF FIGURES

In order that the invention may be fully understood and readily put into practical effect there shall now be described by way of non-limitative example only exemplary embodiments of the present invention, the description being with reference to the accompanying illustrative drawings in which:

FIG. 1a is schematic drawings illustrating a leavening process to prepare rGO foams;

FIG. 1b is a photograph of a GO solution used for vacuum filtering;

FIG. 1c is a photograph of a GO layered film on AAO membrane;

FIG. 1d is a photograph of a free-standing GO layered film;

FIG. 1e is a photograph of a free-standing paper-like rGO foam;

FIGS. 2a-c are cross-sectional SEM images at different magnification levels of rGO foams formed at 90° C. with 80 μL hydrazine monohydrate for 10 hours in an autoclave;

FIG. 2d is cross-sectional SEM image of an rGO film having a compact structure;

FIG. 2e is an FTIR spectrum of a GO layered film before reduction (bottom curve) and an rGO foam (top curve) after reduction;

FIG. 2f is a Raman spectrum of a GO layered film before reduction (bottom curve) and an rGO foam (top curve) after reduction;

FIG. 3a is a cross-sectional SEM image of an rGO foam formed at 90° C. for 10 hours in the autoclave with 0 μL of hydrazine monohydrate;

FIG. 3b is a cross-sectional SEM image of an rGO foam formed at 90° C. for 10 hours in the autoclave with 5 μL of hydrazine monohydrate;

FIG. 3c is a cross-sectional SEM image of an rGO foam formed at 90° C. for 10 hours in the autoclave with 10 μL of hydrazine monohydrate;

FIG. 3d is a cross-sectional SEM image of an rGO foam formed at 90° C. for 10 hours in the autoclave with 20 μL of hydrazine monohydrate;

FIG. 3e is a cross-sectional SEM image of an rGO foam formed at 90° C. for 10 hours in the autoclave with 40 μL of hydrazine monohydrate; the different volumes of hydrazine monohydrate (a) 0, (b) 5 μL, (c) 10 μL, (d) 20 μL, and (e) 40 μL, (f)

FIG. 3f is a curve of the volume expansion and mass loss of rGO foams as a function of the volume of hydrazine monohydrate;

FIG. 4a is a schematic diagram of the flexible rGO foam supercapacitor, the distance (l) between two sides of the rGO foam supercapacitor characterizing its bending degree;

FIG. 4b is an optical image of a flexible rGO foam supercapacitor;

FIG. 4c is cyclic voltammetry (CV) curves of a representative rGO foam supercapacitor at different scan rates;

FIG. 4d is a charge and discharge curve of rGO foam supercapacitor at a current of 0.5 A g⁻¹;

FIG. 4e is a Nyquist impedance plot of the rGO foam supercapacitor with frequency ranging from 10 kHz to 1 Hz;

FIG. 4f is CV curves of the rGO foam supercapacitor before bending (l=3 cm) and after bending (l=2 cm) bending;

FIGS. 5a and b are photographs of a layer of motor oil removed by dabbing the oil with free-standing rGO foams

FIG. 5c is a plot of absorption capacities of the rGO foams for a selection of motor oils and organic solvents in terms of its weight gain, the motor oils being labelled with Oil Blue N dye for clear visualization;

FIG. 5d is a plot of absorption capacities of the rGO foams, GO films, and graphite for a selection of motor oils;

FIG. 5e is a plot of selective absorption recyclability of RGO foam over the cycles (▪: the restored weight of rGO foams after washing with hexane, ▴: the weight gain after absorption of oil during different cycles);

FIG. 6 is a strain-stress curve of an rGO foam;

FIG. 7a is a photograph of an rGO foam reduced by hydrazine in autoclave at 90° C. for 10 h;

FIG. 7b is a photograph of an rGO film reduced by toluene in autoclave at 90° C. for 10 h;

FIG. 7c is a photograph of an rGO film reduced by benzene in autoclave at 90° C. for 10 h;

FIG. 7d is a photograph of an rGO film reduced by water in autoclave at 90° C. for 10 h;

FIG. 7e is an SEM image of an rGO foam reduced by hydrazine;

FIG. 7f is an SEM image of an rGO film reduced by toluene;

FIG. 7g is an SEM image of an rGO film reduced by benzene;

FIG. 7h is an SEM image of an rGO film reduced by water;

FIG. 8a is an illustration of wetting behaviour of rGO foam in water; and

FIG. 8b is an illustration of wetting behaviour of rGO foam in oil.

### DETAILED DESCRIPTION

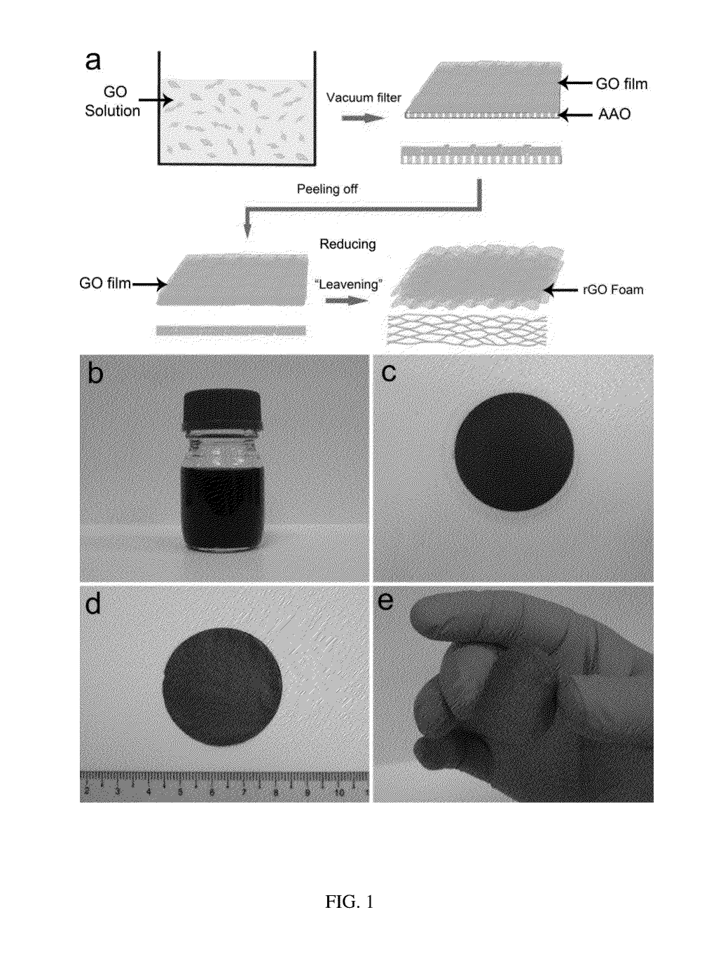

Exemplary embodiments of the invention will be described with reference to FIGS. 1 to 8 below.

Fabrication and Characterization of rGO Foams

As shown in FIG. 1, in an exemplary method of preparing rGO, aqueous GO dispersions or a GO colloidal suspension (˜2.5 mg mL⁻¹) were first prepared by oxidizing graphite powder via a modified Hummers method (FIG. 1b).^{[11]} Then, flow-directed assembly, using a shearing field-assisted alignment of suspensions, was used to assemble GO sheets into nacre-like layered films.^{[11]} In this procedure, aqueous GO dispersions were filtrated through a porous membrane filter, i.e., anodized aluminum oxide (AAO) membranes with a pore diameter of 20 nm (FIG. 1c). The reason for the choice of this method is that it is an effective way to prepare free-standing GO films with compact layered structures and an inter-layer distance of 0.83 nm.^{[11]} During the process of vacuum filtration, the concentration of graphene oxide sheets in the suspension increases, resulting in a significant enhancement in sheet-to-sheet interactions. During this stage, the sheets are more likely to be aligned on top of each other in the ever-growing deposit and are probably also smoothed out” by the liquid flow.^{[11]} In this way, GO films were first prepared by vacuum filtration using an AAO porous membrane (Whatman, pore diameter: 0.02 μm) as a filter. In addition, the thickness of GO films can be controlled by the concentration and volume of GO solution.

To achieve the free-standing film, in order to meet the demand for flexible devices, the GO film has to be peeled off from the AAO membrane, as depicted in FIG. 1a. It can be seen from FIG. 1d that the GO film can be peeled from AAO membrane integrally. After peeling off from AAO membranes, the free-standing GO layered films (FIG. 1d) were put into a sealed environment such as an autoclave, and then hydrazine monohydrate (98%) was added into the autoclave, such as a Teflon vessel (50 mL) prefilled with 80 μL hydrazine monohydrate. The GO films were suspended well above the hydrazine monohydrate level to avoid direct wetting. The vessel was then sealed in a stainless steel autoclave and heated to 90° C. for 10 hours to obtain rGO foam. Thus, after peeling off from the AAO membrane, the GO film was chemically reduced and leavened to obtain the RGO foam, as depicted in FIG. 1a.

The formation of foamed structures with ˜50 times of volume expansion and ˜30% of mass loss was clearly observed, as shown in FIG. 1e. The role of the hydrazine vapor here is to initiate the chemical reduction of GO to rGO with the rapid evolution of gaseous species. It is noted that the resulting rGO foams still keep the paper-like and flexible properties after the thermal treatment, as shown in FIG. 1e, therefore making it applicable to flexible and printable devices.

The mechanical properties of the rGO foams were also tested, as shown in FIG. 6. To test the mechanical properties of rGO foams, the foams were cut to a rectangle shape (size: 10 mm×1 mm). The mechanical properties of rGO foams were tested on a tensile testing machine (DMA Q800—dynamic mechanical analyser from TA instruments). It was shown that the tensile strength of the rGO foams is about 3.2 MPa and the Young's modulus of the rGO foams were about 7 and 40 MPa at the first and last tensile stages (i.e. stages I and III), respectively. The tensile strain can be up to about 10%, which is much larger than the case of the compact GO films (<0.6%).^{[11]}

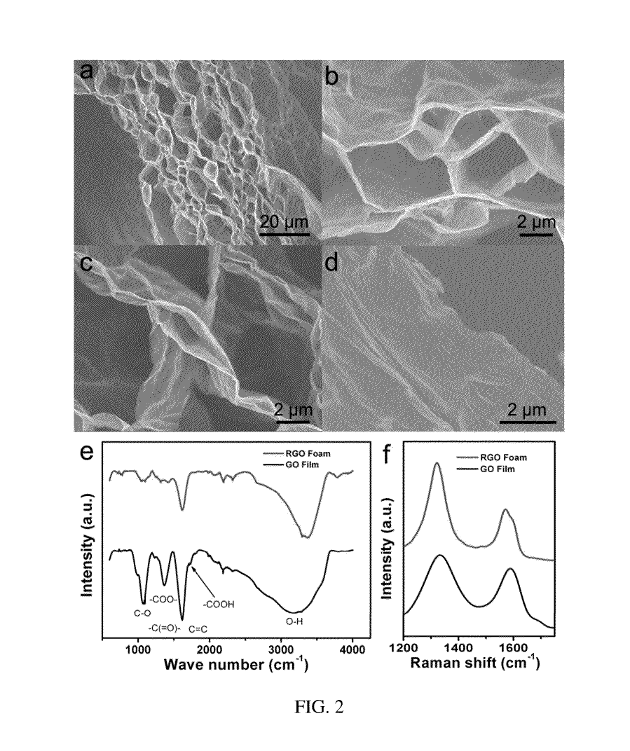

Scanning electron microscopy (SEM) measurements or analyses were carried out where the morphology and the microstructures of rGO foams were characterized by a FE-SEM (JSM-7600F). FIGS. 2a-2d clearly indicate the formation of an open porous network with pore sizes in the range of sub-micrometer to several micrometers in the graphene foams, as seen from a cross-sectional view in FIG. 2a. FIG. 2a thus shows that the porous structures were formed in the rGO foam. The sizes of the pores are more than several microns. As known, the diffusion layer thickness in electrochemical reactions is about several microns, even dozens of microns. Therefore, the pore size in the present rGO foam would be helpful for solution diffusion in electrochemistry.

In addition, it is interesting that the layers in the rGO foam and the porous walls in the foams are continuously cross-linked and not simply and completely separated between different layers, as shown in FIG. 2b. Such continuous cross-linked structures not only effectively overcome the restack between graphene sheets, but also possess better conductive contacts between the sheets to lower the resistance of foams (less than 100 Ω square-1).^{[45]} Furthermore, the porous walls consisting of thin layers of stacked graphene sheets in foams are not fully compact and there are still small gaps in the walls, as shown in FIG. 2c. The rGO layers in foam are thus not compact structures and small gaps exist. In fact, the rGO foam presented a hierarchical structure. The rGO foam overcomes effectively the self-agglomeration of graphene sheets. FIG. 2d is an SEM image of an rGO film with a compact structure. From FIG. 2d, it can be seen that such compact structure rGO sheets form irreversible agglomerates and are restacked to the structure like graphite because of the van der Waals interactions. Unique properties of 2D graphene sheets are thus lost, unlike the present rGO foam with porous and continuous cross-linked structures. It has been reported that when GO sheets were chemically reduced by hydrazine monohydrate or electrochemical reaction, CO, CO₂ and steam would be yielded. Hence, the chemical reduction and thermal decomposition of GO could be accompanied by a vigorous release of gas, resulting in a rapid thermal expansion of the material. This is evidenced by the large volume expansion observed.

Different spectroscopy measurements were used to confirm the formation of rGO in the foams. First, characteristic G and D bands of Raman spectra for the films before and after hydrazine vapor treatment clearly indicated the formation of rGO in the foams. The sheet resistance of the rGO foams was measured by a Fluke 179 True RMS Multimeter. The Raman spectra were obtained with a spectrophotometer (WITec alpha 300 R). The operating wavelength is 633 nm. Raman spectrum can reflect the significant structural changes during the chemical process from GO to rGO. The intensity ratio I_{D}/I_{G} of rGO foam is slightly increased in comparison with that of GO film, as shown in FIG. 2f. This change is attributed to the increased defect concentration existed in rGO relative to that in GO and the numerous new graphene domains that were created during the chemical process from GO to rGO and are smaller in size than that present in the film before reduction.^{[10]} The I_{D}/I_{G} intensity ratio was an indicator of the disorder degree and average size of the sp² domains. For the GO layered films, there were two prominent peaks at 1589 and 1332 cm⁻¹ (FIG. 2f) corresponding to the well documented G and D bands.^{[41]} After the hydrazine treatment to convert graphene layered films to graphene foams, G and D bands (at 1571 and 1321 cm⁻¹, respectively) were still present, but the values of I_{D}/I_{G} increased in comparison to those of the GO films. This change strongly suggested that GO was chemically converted to rGO in the foams after hydrazine thermal exposure.^{[41]}.

The significant structural changes occurring during the chemical processing from GO film to RGO foam can be reflected in Fourier transform infrared spectroscopy (FTIR) spectrum. FTIR spectra were recorded on a FT-IR system (Perkin Elmer). The significant changes in Fourier transform infrared (FTIR) spectra (FIG. 2f) supported the formation of rGO in the foams.^{[44, 46]} The most prominent features in the spectrum are the adsorption bands corresponding to the O—H groups at 3178 cm⁻¹, the —COOH group stretching at 1733 cm⁻¹, the —C(═O)-group stretching at 1615 cm⁻¹, the —COO— groups at 1367 cm⁻¹, and the C—O stretching at 1066 cm⁻¹. The FT-IR spectrum shows a significant decrease in the intensity of the peaks related to oxygen functional groups, indicating that oxygen functional groups on GO sheet was significantly removed, accompanying by vigorous release of gas, during the reduction process. Therefore, the release of gas formed in the rGO film would separate the staked GO layer and formed rGO foam, like the process of making bread. The significant decrease in the intensity of adsorption bands corresponding to the oxygen functional groups (1615 cm⁻¹ due to the C═O stretching, 1367 cm⁻¹ due to carboxy C—O stretching, and 1066 cm⁻¹ due to alkoxy C—O stretching) indicated that oxygen functional groups on GO sheets were significantly removed, accompanied by the release of carbonaceous gases and H₂O, during the thermal process. For instance, after the reduction, the peak intensity of alkoxy C—O stretching at 1066 cm⁻¹ and carboxy C—O stretching at 1367 cm⁻¹ decreased 83% and 75%, respectively. Finally, the 30% mass loss during the “leavening” process is close to the reported case under thermal reduction,^{[47]} indicating that most GO sheets in the films were reduced.

It is to be noted that there are two key points for the success of leavening GO layered films to rGO foams: (1) compact layered GO structures as “dough” and (2) hydrazine vapor to initiate the chemical reduction of GO to rGO with the rapid evolution of gaseous species. As discussed above, the compact GO layered films prepared by flow-directed assembly are critical for the formation of rGO foams. As a control experiment, we prepared multilayered GO/Au-nanoparticle films, in which 13 nm Au nanoparticles acted as spacers to separate the GO sheets and block the formation of compact layered films. Such multilayered GO/Au-nanoparticle films were formed by alternatively electrophoretic deposition of GO sheets and Au-nanoparticles. However, after the reduction of multilayered GO/Au-nanoparticle films by hydrazine vapor at the same condition used for the rGO foam formation, we did not see obvious volume expansion or the formation of porous structures in the films. In our earlier work, when the graphene sheets were assembled into honeycomb structures, there was no porous structure formation after the hydrazine reduction, since the sheets were randomly distributed in the honeycomb structures.^{[6]}

In addition, other work has demonstrated that the morphology of the rGO films would not change after thermal and chemical reduction by hydrazine vapor if the GO sheets were less ordered in the films.^{[6, 48]} These suggested that the compact layered films would help retain the rapid evolution of gaseous species (H₂O and CO₂) during reduction, while the gas could be simultaneously incorporated into compact layered films to form the porous rGO foams with ˜50 times volume expansion, while for the less compact films, the gas yielded during reduction was released quickly because of the gaps between the GO layers, and volume expansion was not observed.

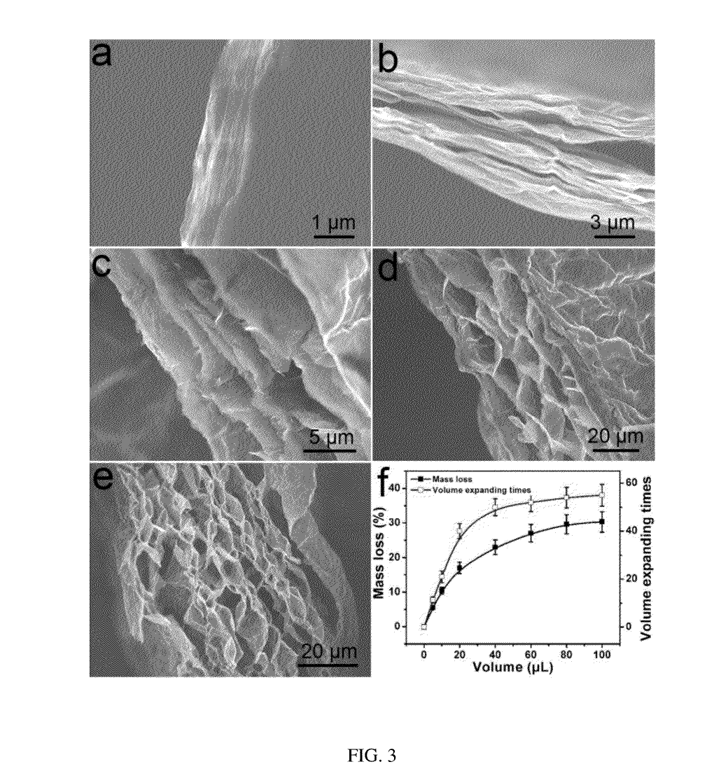

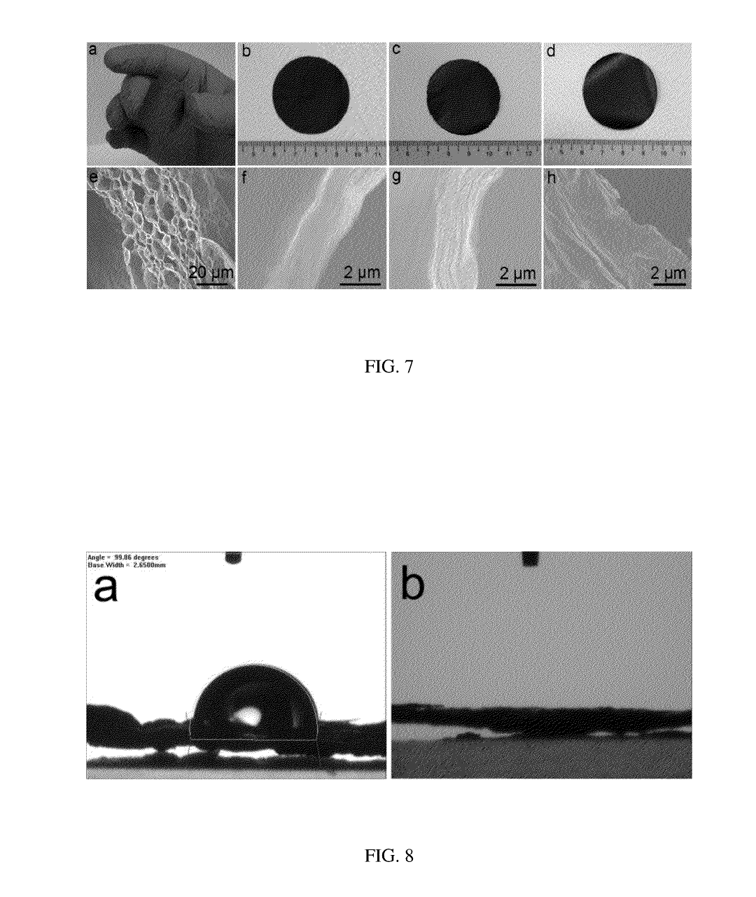

Furthermore, the hydrazine vapor to initiate the chemical reduction of GO to rGO with the rapid evolution of gaseous species is critical for the formation of rGO foams. To confirm this, several control experiments were carried out. First, when the compact GO layered films were placed into the autoclave in the presence of 80 μL water instead of hydrazine monohydrate and thermally treated at 90° C. for 10 hours, the morphology of the layered films remained unchanged as shown in FIGS. 7d and 7h. Furthermore, when the films were steamed by dry heating or in the presence of non-reducing solvents (e.g. toluene and benzene) rather than hydrazine monohydrate at the same conditions, only compact structures were observed as can be seen in FIGS. 3a, 7b, 7f, 7c and 7g. Thus, FIGS. 7a and 7e show optical and SEM image images, respectively, of rGO foam obtained by reducing GO film using hydrazine. The rGO foam has a porous structure. FIGS. 7b-d and 7f-h show the optical and SEM images of rGO films reduced by toluene, benzene and water in autoclave at 90° C. for 10 h. From FIGS. 7b-d and FIGS. 7f-h, we can see that the films reduced by toluene, benzene and water in autoclave retain a compact structure, like GO film. The square resistance of the rGO film reduced by toluene and benzene is ˜5 MΩ and that of the rGO film reduced by water in autoclave is ˜6 KΩ, which is much higher than that of rGO foam reduced by hydrazine. It indicates that GO films cannot be completely reduced by toluene, benzene and water in autoclave. Hence, not enough gas was obtained, which resulted in rGO films retaining a compact structure, as shown in FIG. 7.

It has been reported that thermal annealing could lead to the reduction of GO to rGO,^{[49]} but under the present conditions, thermal reduction could not trigger porous structure formation. Therefore, it is concluded that the rapid evolution of gaseous species (like H₂O and CO₂) formed during the chemical reduction process by hydrazine vapor is one reason for the porous structure formation. This leads to pores distributed all over the layered film, eventually forming the porous network. Release of gas formed in the graphene films would separate the compacted GO layers to form rGO foams, like the process of making bread from dough. Studies on the GO film prepared by vacuum filter revealed that a layer of water molecules exist between graphene layers.^{[11]} When GO films were steamed by hydrazine vapor, the water molecule layer that exists between graphene layers would provide the route for hydrazine molecules to diffuse into the interior of the film.

Finally, it is noted that the degree of the porosity of the resulting rGO foams can be conveniently controlled by the amount of hydrazine. FIGS. 3a-e shows typical SEM images of the porosity evolution of the rGO foams after thermal steaming (90° C. for 10 hours) under different amount of hydrazine. When the GO layered films were directly heated in the absence of hydrazine, there is no porous structure formation (FIG. 3a). When the GO layered films were directly heated with 5 μL hydrazine monohydrate, there was some small porous structure formation in the layered film (FIG. 3b) with about ˜11 times volume expansion and ˜5% of mass loss. Further increasing the amount of hydrazine in the autoclave led to a much more open porous structure formation (FIGS. 3c-e and FIG. 2a). But it should be noted that the porous structures do not change too much after adding hydrazine monohydrate beyond 40 μL. Hence, volume expansion and mass loss for films after reduction are strongly dependent on the amount of hydrazine, but they do not change much beyond 40 μL of hydrazine monohydrate (FIG. 3f).

It is thus noted that rGO foams prepared by the leavening strategy effectively overcome the self-agglomeration of graphene sheets without the assistance of any spacers or templates. As it is known that the diffusion layer thickness in electrochemical reactions is about several microns, even up to dozens of microns,^{[50]} therefore, the pore size in the present rGO foams would be helpful for solution diffusion in electrochemistry. In addition, since the foams are flexible, such foams having also high surface area and numerous pores can be used to prepare flexible supercapacitors. Furthermore, the rGO foams possess the properties of hydrophobicity, and hence will have superwetting behavior for organic solvents for environmental clean-up.

Fabrication and Characterization of Flexible rGO Foam Supercapacitors

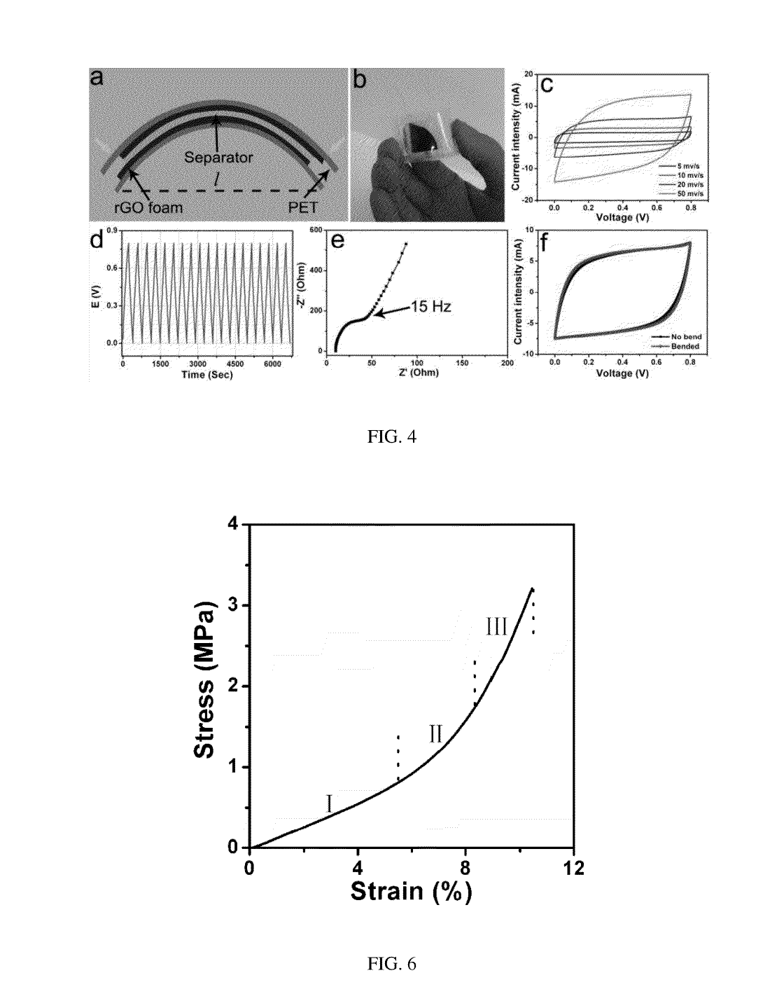

Since the free-standing rGO foams with continuous cross-linking porous structures overcome the re-stacking, it results in higher active electrochemical surface area and good conductivity. These rGO foams can be used for fabricating supercapacitor devices where neither an insulating binder nor a low capacitance conducting additive is required. In traditional supercapacitors, metallic current collectors (metallic foils or foams) are normally used as electrode materials for both anode and cathode due to the poor conductivity of active electrode materials.^{[51]} But the use of metallic current collectors will make the supercapacitors too heavy or bulky, which in turn restricts the use of these supercapacitors in the applications that are constrained by space and weight.^{[52]} In a proof-of-concept experiment, flexible rGO foam supercapacitors were built using free-standing rGO foams as both current collectors and electrodes as shown in FIGS. 4a and 4b. Before fabricating rGO foam supercapacitors, rGO foams were dipped into sodium dodecyl benzene sulfonate (SDBS, 2 wt %) solution for 10 min. Then the rGO foams were rinsed and dried in air at room temperature. The free-standing rGO foams treated by SDBS were spread out onto a flexible substrate such as a PET (polyethylene terephthalate) substrate as both current collector and electrodes. Filter paper served as a flexible separator and the electrolyte was 1M H₂SO₄. Then, the separator and electrolyte were sandwiched by the rGO foams on the PET substrates, as shown in FIG. 4a. The fabricated supercapacitor was flexible, as shown in FIG. 4b.

Cyclic voltammetry (CV) of the multilayered hybrid film supercapacitors was performed by a CHI 660D instrument (CHI Instruments). The galvanostatic charge-discharge of the supercapacitors at the operation voltage range (0 to 0.8 V) was carried out on a supercapacitor test system (Solartron, 1470E). FIG. 4c shows the CV curves of a representative rGO foam supercapacitor at different scan rates. CVs of the supercapacitor were found to be rectangular in shape within a selected range of potential, indicating an excellent capacitance behavior. FIG. 4d is the typical galvanostatic charge/discharge curve of the rGO foam supercapacitor. The discharge curve is nearly a straight line, indicating a good electrical double layer performance. The specific capacitances Cspe of the supercapacitor devices were calculated from constant current charge/discharge curves using equation (1) below:

$${C}_{spe} = \frac{I}{( d V / d t ) m} \qquad ( 1 )$$

where l is the discharge current, dV/dt represents the slope of the discharge curve and m is the total mass of the rGO foams on both electrodes. The calculated specific capacitance of the resulting rGO foam supercapacitor is about 110 F g⁻¹ for a two-electrode cell.

The calculated specific capacitance of supercapacitor based on rGO foams is much larger than that of supercapacitors using compact rGO films as electrodes (17 F g-1) and reported rGO film supercapacitors.^{[53-54]} Further electrochemical investigation was carried out to understand in depth the device performance of rGO foam supercapacitors. The impedance spectrum of the rGO foam supercapacitor is shown as Nyquist plots in FIG. 4e. The vertical shape at lower frequencies indicates a pure capacitive behavior, representative of the ion diffusion in the electrode structure. It is noticeable that, at low frequencies, the Nyquist plot corresponding to the capacitive response of the rGO foam electrodes is an almost vertical line, but not a rigorous vertical line. It may be ascribed to the distribution of pore size of rGO foam.^{[55]} In FIG. 4e, it can be seen that the knee frequency is 15 Hz, indicating the availability of the rGO foam supercapacitors. In order to demonstrate the flexible property of the resulting rGO foam supercapacitors, we did the CV measurement of a representative rGO foam supercapacitor (device size: 3 cm×3 cm, rGO foam electrode size: 1.5 cm×1.5 cm) before and after bending. It was found that there was nearly no obvious deviation in the CV curves (FIG. 4f) when the distance between two sides of the supercapacitor was changed from 3 to 2 cm under bending. This suggested that the rGO foam supercapacitors are quite stable under bending, and the rGO foams are suitable for the flexible device applications.

Reduced Graphene Oxide Foams as Absorbents

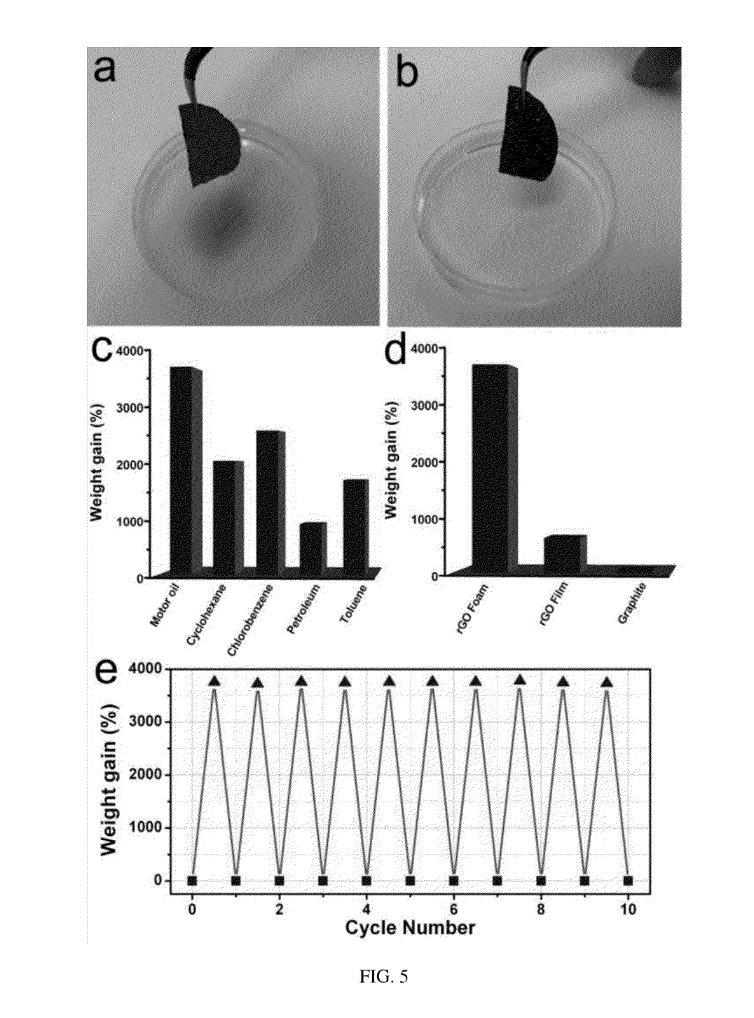

Finally, as expected, rGO foams possess the properties of hydrophobicity and superwetting behavior for organic solvents (see FIG. 8) and good capillary action, an overall property that may be called selective superabsorbance, which makes rGO foams an excellent candidate for selective superabsorbance.^{[56]} In uptake studies of the rGO foams, before presenting the selective absorption behavior for motor oil, the motor oil was labeled with Oil Blue N dye. Before and after absorbing oil or organic solvents, rGO foams, rGO layered films and graphite were weighed by a balance (Mettler Toledo CXS 205). When the rGO foams were brought into contact with a layer of oil on a water surface, the foams quickly absorbed the oil while repelling the water, as shown in FIGS. 5a and 5b. The rGO foams showed uptake capacities up to 40 times its weight for a collection of oil, making this membrane an ideal candidate as an oil absorbent. FIG. 5c shows the absorption capacities of rGO foams, with a calculated density of about 0.03 g cm⁻³ (much smaller than ˜1.8 g cm⁻³ for GO film) for a selection of motor oil and organic solvents in terms of its weight gain. The uptake capacities of rGO foams are up to about 37 times its weight for a collection of motor oil and up to about 26 times for organic solvents, which is larger than that of inorganic nanowire membranes.^{[56]} This is to say, the rGO foams absorb on average 1.1 ton m⁻³ of motor oil, making these foams an ideal candidate as oil absorbent.

As a control experiment, the absorption capacities of compact rGO films and graphite for motor oil were also tested. Absorption capacities of rGO foams are much higher than that of compact rGO films and graphite, as shown in FIG. 5d. One major advantage of the rGO foams is their chemical stability for organic solvents. So, the foams can be regenerated after each use by immersing the foams absorbed with oil into hexane, making recycling schemes for both the foams and the absorbed liquid feasible, as shown in FIG. 5e. The rGO foams still keep their original paper-like morphology and high selective absorption capability after more than 10 cycles. This will make the graphene foams ideal candidates for practical applications in the removal of organics, particularly in the field of oil spill cleanup. In principle, the “leavening” strategy could be easily used to convert compact graphene structures (any size) to the rGO foams with porous structures at low cost. But the remaining challenge is how to fabricate the compact graphene film in a large amount in an efficient way.

In summary, autoclaved leavening and steaming of GO layered films creates paper-like, lightweight, and electrically conductive rGO foams with open porous and continuous cross-link structures. Thermal steaming of GO layered films with hydrazine would be the key reason for the formation of rGO foams. Compared to the regular rGO layered films, the rGO foams show greatly improved performance as flexible electrode materials for supercapacitors and selective organic absorbents. The ease of fabrication and enhanced performance could make porous rGO foams a general and effective template for designing high performance energy storage or environmental remediation materials.

Whilst there has been described in the foregoing description exemplary embodiments of the present invention, it will be understood by those skilled in the technology concerned that many variations in details of design, construction and/or operation may be made without departing from the present invention. For example, while hydrazine monohydrate has been described above as the chemical reducing agent, other chemical reducing agents such as hydroquinone or hydrogen iodide in acetic acid (where hydrogen iodide is the reducing agent and the acetic acid is the solvent that dissolves the hydrogen iodide) may also be used. In addition, other reductants that can be in a vaporized form at a high temperature in an autoclave can also be used in the preparation of rGO foams.

### REFERENCES

[1] Q. M. Ji, I. Honma, S. M. Paek, M. Akada, J. P. Hill, A. Vinu, K. Ariga, Angew. Chem. Int. Ed. 2010, 49, 9737.
[2] D. C. Wei, Y. Q. Liu, Adv. Mater. 2010, 22, 3225.
[3] H. Chen, M. B. Muller, K. J. Gilmore, G. G. Wallace, D. Li, Adv. Mater. 2008, 20, 3557.
[4] J. Kim, L. J. Cote, F. Kim, W. Yuan, K. R. Shull, J. X. Huang, J. Am. Chem. Soc. 2010, 132, 8180.
[5] V. C. Tung, J. Kim, L. J. Cote, J. X. Huang, J. Am. Chem. Soc. 2011, 133, 9262.
[6] S. Y. Yin, Y. Y. Zhang, J. H. Kong, C. J. Zou, C. M. Li, X. H. Lu, J. Ma, F. Y. C. Boey, X. D. Chen, ACS Nano 2011, 5, 3831.
[7] X. W. Yang, J. W. Zhu, L. Qiu, D. Li, Adv. Mater. 2011, 23, 2833.
[8] D. W. Wang, F. Li, J. P. Zhao, W. C. Ren, Z. G. Chen, J. Tan, Z. S. Wu, I. Gentle, G. Q. Lu, H. M. Cheng, ACS Nano 2009, 3, 1745.
[9] F. Liu, T. S. Seo, Adv. Funct. Mater. 2010, 20, 1930.
[10] L. H. Tang, Y. Wang, Y. M. Li, H. B. Feng, J. Lu, J. H. Li, Adv. Funct. Mater. 2009, 19, 2782.
[11] D. A. Dikin, S. Stankovich, E. J. Zimney, R. D. Piner, G. H. B. Dommett, G. Evmenenko, S. T. Nguyen, R. S. Ruoff, Nature 2007, 448, 457.
[12] Z. S. Wu, S. F. Pei, W. C. Ren, D. M. Tang, L. B. Gao, B. L. Liu, F. Li, C. Liu, H. M. Cheng, Adv. Mater. 2009, 21, 1756.
[13] S. A. Hasan, J. L. Rigueur, R. R. Harl, A. J. Krejci, I. Gonzalo-Juan, B. R. Rogers, J. H. Dickerson, ACS Nano 2010, 4, 7367.
[14] J. J. Xu, K. Wang, S. Z. Zu, B. H. Han, Z. X. Wei, ACS Nano 2010, 4, 5019.
[15] S. Biswas, L. T. Drzal, Chem. Mater. 2010, 22, 5667.
[16] Y. Q. Sun, Q. O. Wu, G. Q. Shi, Energy Environ. Sci. 2011, 4, 1113.
[17] Y. X. Xu, H. Bai, G. W. Lu, C. Li, G. Q. Shi, J. Am. Chem. Soc. 2008, 130, 5856.
[18] X. Zhao, C. M. Hayner, M. C. Kung, H. H. Kung, ACS Nano 2011, 5, 8739.
[19] Q. Su, Y. Y. Liang, X. L. Feng, K. Mullen, Chem. Commun. 2010, 46, 8279.
[20] Z. J. Fan, J. Yan, L. J. Zhi, Q. Zhang, T. Wei, J. Feng, M. L. Zhang, W. Z. Qian, F. Wei, Adv. Mater. 2010, 22, 3723.
[21] C. Y. Su, A. Y. Lu, Y. P. Xu, F. R. Chen, A. N. Khlobystov, L. J. Li, ACS Nano 2011, 5, 2332.
[22] D. S. Yu, L. M. Dai, J. Phys. Chem. Lett. 2010, 1, 467.
[23] K. Ariga, T. Mori, J. P. Hill, Adv. Mater. 2012, 24, 158.
[24] K. Sakakibara, J. P. Hill, K. Ariga, Small 2011, 7, 1288.
[25] K. Ariga, A. Vinu, Y. Yamauchi, Q. M. Ji, J. P. Hill, B Chem Soc Jpn 2012, 85, 1.
[26] M. Osada, T. Sasaki, Adv. Mater. 2012, 24, 210.
[27] Q. Wu, Y. X. Xu, Z. Y. Yao, A. R. Liu, G. Q. Shi, ACS Nano 2010, 4, 1963.
[28] Y. X. Xu, Q. O. Wu, Y. Q. Sun, H. Bai, G. Q. Shi, ACS Nano 2010, 4, 7358.
[29] S. Park, N. Mohanty, J. W. Suk, A. Nagaraja, J. H. An, R. D. Piner, W. W. Cai, D. R. Dreyer, V. Berry, R. S. Ruoff, Adv. Mater. 2010, 22, 1736.
[30] S. Biswas, L. T. Drzal, ACS Appl. Mater. Interfaces 2010, 2, 2293.
[31] Q. Su, S. P. Pang, V. Alijani, C. Li, X. L. Feng, K. Mullen, Adv. Mater. 2009, 21, 3191.
[32] C. B. Liu, K. Wang, S. L. Luo, Y. H. Tang, L. Y. Chen, Small 2011, 7, 1203.
[33] S. J. Guo, S. J. Dong, E. W. Wang, ACS Nano 2010, 4, 547.
[34] S. B. Yang, X. L. Feng, L. Wang, K. Tang, J. Maier, K. Mullen, Angew. Chem. Int. Ed. 2010, 49, 4795.
[35] V. C. Tung, J. H. Huang, I. Tevis, F. Kim, J. Kim, C. W. Chu, S. I. Stupp, J. X. Huang, J. Am. Chem. Soc. 2011, 133, 4940.
[36] L. J. Cote, R. Cruz-Silva, J. X. Huang, J. Am. Chem. Soc. 2009, 131, 11027.
[37] X. H. Cao, Y. Shi, W. H. Shi, G. Lu, X. A. Huang, Y. Q. Y., Q. C. Zhang, H. Zhang, Small 2011, 7, 3163.
[38] J. Y. Luo, H. D. Jang, T. Sun, L. Xiao, Z. He, A. P. Katsoulidis, M. G. Kanatzidis, J. M. Gibson, J. X. Huang, ACS Nano 2011, 5, 8943.
[39] Y. X. Xu, K. X. Sheng, C. Li, G. Q. Shi, ACS Nano 2010, 4, 4324.
[40] Z. P. Chen, W. C. Ren, L. B. Gao, B. L. Liu, S. F. Pei, H. M. Cheng, Nat. Mater. 2011, 10, 424.
[41] S. Stankovich, D. A. Dikin, R. D. Piner, K. A. Kohlhaas, A. Kleinhammes, Y. Jia, Y. Wu, S. T. Nguyen, R. S. Ruoff, Carbon 2007, 45, 1558.
[42] X. F. G. X. F. Gao, J. Jang, S. Nagase, J. Phys. Chem. C 2010, 114, 832.
[43] D. R. Dreyer, S. Park, C. W. Bielawski, R. S. Ruoff, Chem. Soc. Rev. 2010, 39, 228.
[44] S. J. An, Y. W. Zhu, S. H. Lee, M. D. Stoller, T. Emilsson, S. Park, A. Velamakanni, J. H. An, R. S. Ruoff, J. Phys. Chem. Lett. 2010, 1, 1259.
[45] W. J. Ma, L. Song, R. Yang, T. H. Zhang, Y. C. Zhao, L. F. Sun, Y. Ren, D. F. Liu, L. F. Liu, J. Shen, Z. X. Zhang, Y. J. Xiang, W. Y. Zhou, S. S. Xie, Nano Lett. 2007, 7, 2307.
[46] S. Stankovich, R. D. Piner, X. Q. Chen, N. Q. Wu, S. T. Nguyen, R. S. Ruoff, J. Mater. Chem. 2006, 16, 155.
[47] P. G. Ren, D. X. Yan, X. Ji, T. Chen, Z. M. Li, Nanotechnology 2011, 22, 055705.
[48] Q. Y. He, H. G. Sudibya, Z. Y. Yin, S. X. Wu, H. Li, F. Boey, W. Huang, P. Chen, H. Zhang, ACS Nano 2010, 4, 3201.
[49] F. Kim, J. Y. Luo, R. Cruz-Silva, L. J. Cote, K. Sohn, J. X. Huang, Adv. Punct. Mater. 2010, 20, 2867.
[50] A. J. Bard, L. R. Faulkner, Electrochemical Methods: Fundamentals and Applications;, Wiley, N.Y., 1980.
[51] Y. Zhang, H. Feng, X. B. Wu, L. Z. Wang, A. Q. Zhang, T. C. Xia, H. C. Dong, X. F. Li, L. S. Zhang, Int. J. Hydrogen Energy 2009, 34, 4889.
[52] Z. Q. Niu, W. Y. Zhou, J. Chen, G. X. Feng, H. Li, W. J. Ma, J. Z. Li, H. B. Dong, Y. Ren, D. Zhao, S. S. Xie, Energy Environ. Sci. 2011, 4, 1440.
[53] Y. Chen, X. O. Zhang, D. C. Zhang, P. Yu, Y. W. Ma, Carbon 2011, 49, 573.
[54] Y. Chen, X. Zhang, P. Yu, Y. W. Ma, J. Power Sources 2010, 195, 3031.
[55] C. T. Hsieh, Y. W. Chou, W. Y. Chen, J. Solid State Chem. 2008, 12, 663.
[56] J. K. Yuan, X. G. Liu, O. Akbulut, J. Q. Hu, S. L. Suib, J. Kong, F. Stellacci, Nat. Nanotechnol. 2008, 3, 332.
[57] C. Xu, X. Wang, J. W. Zhu, J. Phys. Chem. C 2008, 112, 19841.
[58] D. Chen, X. Y. Wang, T. X. Liu, X. D. Wang, J. Li, Acs Applied Materials & Interfaces 2010, 2, 2005.
[59] X. B. Yan, J. T. Chen, J. Yang, Q. J. Xue, P. Miele, Acs Applied Materials & Interfaces 2010, 2, 2521.
[60] Z. S. Wu, W. C. Ren, D. W. Wang, F. Li, B. L. Liu, H. M. Cheng, Acs Nano 2010, 4, 5835.

1. A method of preparing a reduced graphene oxide foam, the method comprising the steps of:
preparing a colloidal suspension of graphene oxide;
forming a graphene oxide compact layered film from the colloidal suspension of graphene oxide using flow-directed assembly; and
chemically reducing the graphene oxide compact layered film using a chemical reducing agent to form a porous and continuous cross-linked structure that is the reduced graphene oxide foam.

2. The method of claim 1, wherein the chemically reducing comprises heating the graphene oxide compact layered film in the presence of the chemical reducing agent in a sealed environment such that gas that is released during the chemical reduction forms pores in the layered film to form the porous graphene oxide network.

3. The method of claim 2, wherein the chemical reducing agent comprises hydrazine monohydrate.

4. The method of claim 2, wherein the graphene oxide compact layered film is prevented from being in direct wetting contact with the chemical reducing agent in the sealed environment and is allowed to contact only the vapour of the chemical reducing agent in the sealed environment.

5. The method of claim 2, wherein the heating is at a temperature of about 90° C. for about 10 hours.

6. The method of claim 1, wherein the flow-directed assembly comprises filtering the colloidal suspension of graphene oxide through a porous membrane to obtain the graphene oxide compact layered film on the porous membrane.

7. The method of claim 6, further comprising removing the graphene oxide compact layered film from the porous membrane before chemically reducing the graphene oxide compact layered film.

8. The method of claim 6, wherein the porous membrane is an anodized aluminium oxide membrane having a pore size of about 20 nm.

9. The method of claim 1, wherein the degree of porosity in the reduced graphene oxide foam is controlled by the volume of the chemical reducing agent used.

10. The method of claim 1, wherein the volume of the chemical reducing agent used ranges from about 5 μL to about 40 μL.

11. An oil absorbent comprising a reduced graphene oxide foam prepared according to the method of claim 1, the reduced graphene oxide foam being hydrophobic and exhibiting superwetting behaviour for organic solvents.

12. The oil absorbent of claim 11, having an oil absorption capacity of about 1.1 ton m⁻³.

13. A flexible supercapacitor having a current collector and an electrode, each of the current collector and the electrode comprising a reduced graphene oxide foam prepared according to the method of claim 1.

14. The flexible supercapacitor of claim 13, further comprising a flexible separator and an electrolyte disposed between the current collector and the electrode.

15. The flexible supercapacitor of claim 13, wherein the reduced graphene oxide foam is provided on a flexible substrate.
